(19) United States
(12) Patent Application Publication
(10) Pub. No.: US 2014/0042070 A1
(43) Pub. Date: Feb. 13, 2014

(54) FILTERING APPARATUS

(71) Applicant: SHUN-TSUNG LU, TAICHUNG CITY (TW)

(72) Inventor: SHUN-TSUNG LU, TAICHUNG CITY (TW)

(21) Appl. No.: 13/568,403

(22) Filed: Aug. 7, 2012

(51) Int. Cl. B01D 35/30; B01D 29/50

(52) U.S. Cl. 210/232

(57) ABSTRACT

A filtering apparatus has a tank, multiple filters and two brackets. The tank has a hollow main body and a tubular overflow mounted on the main body. The filters are respectively connected with the tank beside the overflow. Each filter has an extension spring and two joints. The joints of each filter are respectively mounted around two opposite ends of the extension spring. The brackets clamp the filters. Because the flow of bulky effluent in the sewage is blocked by the extension springs, the sewage is restrained by the filters.

### BACKGROUND OF THE INVENTION

1. Field of the Invention

The present invention relates to a filtering apparatus, and more particularly to a filtering apparatus that is easily placed at different locations.

2. Description of Related Art

With reference to FIG. 6, a conventional filtering tube 80 is made of metal and has an outer surface and multiple meshes 81. The meshes 81 are formed through the outer surface of the filtering tube 80.

To filter sewage, the sewage flows into the filtering tube 80 via the meshes 81, and the passage of large effluent in the sewage is blocked by the meshes 81.

However, the filtering tube 80 is mounted securely on a pipe by welding, and cannot be detached from the pipe. Consequently, the position of the filtering tube 80 cannot be arbitrarily changed, and the filtering tube 80 cannot be placed at different locations as per requirements.

Furthermore, the undetachable filtering tube 80 has to be cleansed in a limited location and is hard to be cleansed completely, whereby some of the particles still remain on the filtering tube 80. Consequently, a flow of liquid through the filtering tube 80 is impeded and the filtration efficiency weakens.

To overcome the shortcomings, the present invention tends to provide a filtering apparatus to mitigate the aforementioned problems.

### SUMMARY OF THE INVENTION

The main objective of the invention is to provide a filtering apparatus that is easily placed at different locations.

A filtering apparatus has a tank, multiple filters and two brackets. The tank has a hollow main body and a tubular overflow mounted on the main body. The filters are respectively connected with the tank beside the overflow. Each filter has an extension spring and two joints. The joints of each filter are respectively mounted around two opposite ends of the extension spring. The brackets clamp the filters. Because bulky effluent or sediment in sewage is blocked by the extension springs, the sewage is filtered by the filters.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a filtering apparatus in accordance with the present invention;

FIG. 2 is a partially exploded perspective view of the filtering apparatus in FIG. 1;

FIG. 3 is an operational side view in partial section of the filtering apparatus in FIG. 1;

FIG. 4 is a partially exploded perspective view of a second embodiment of the filtering apparatus in accordance with the present invention;

FIG. 5 is an enlarged cross sectional side view of the extension spring of the filtering apparatus in FIG. 1; and

FIG. 6 is a perspective view of a conventional filtering tube in accordance with the present invention.

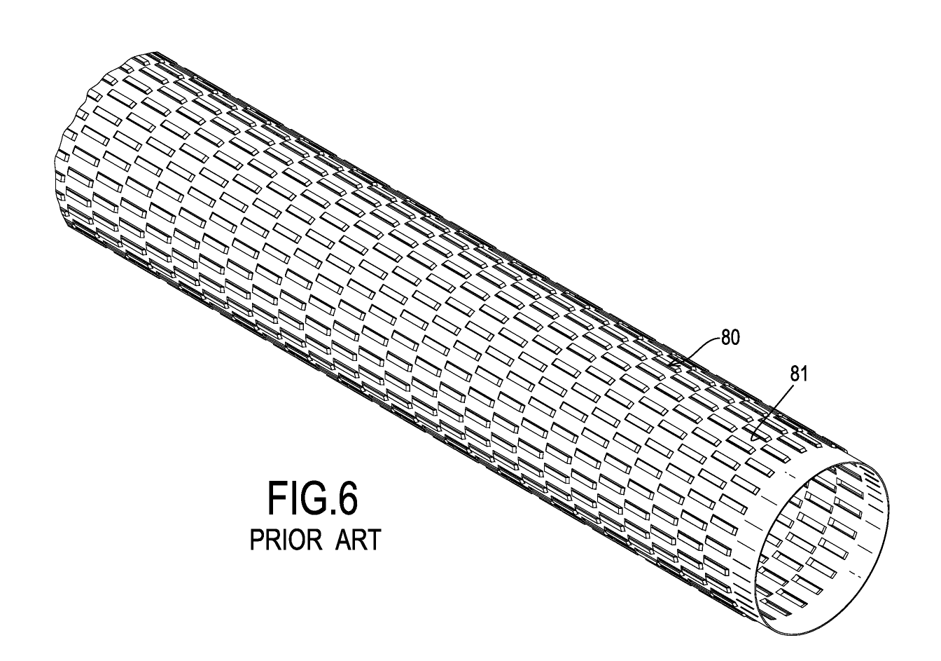

### DETAILED DESCRIPTION OF PREFERRED EMBODIMENT

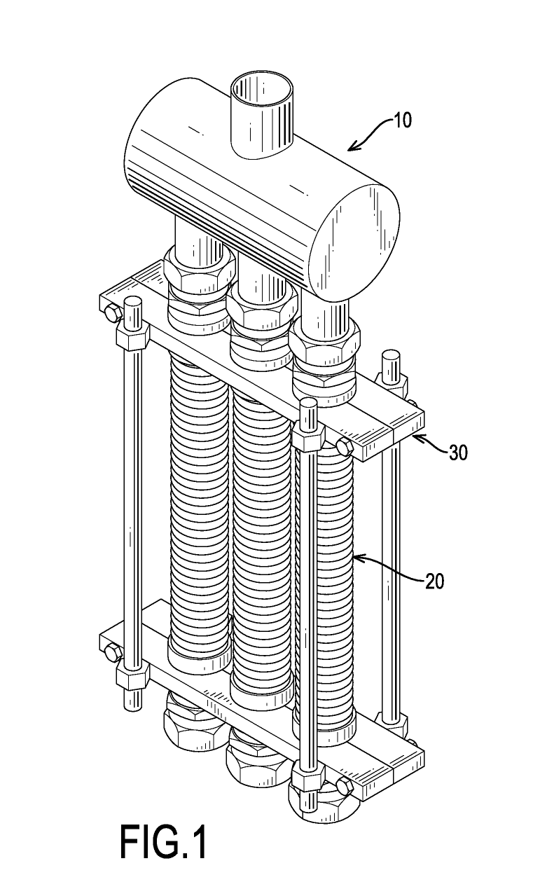

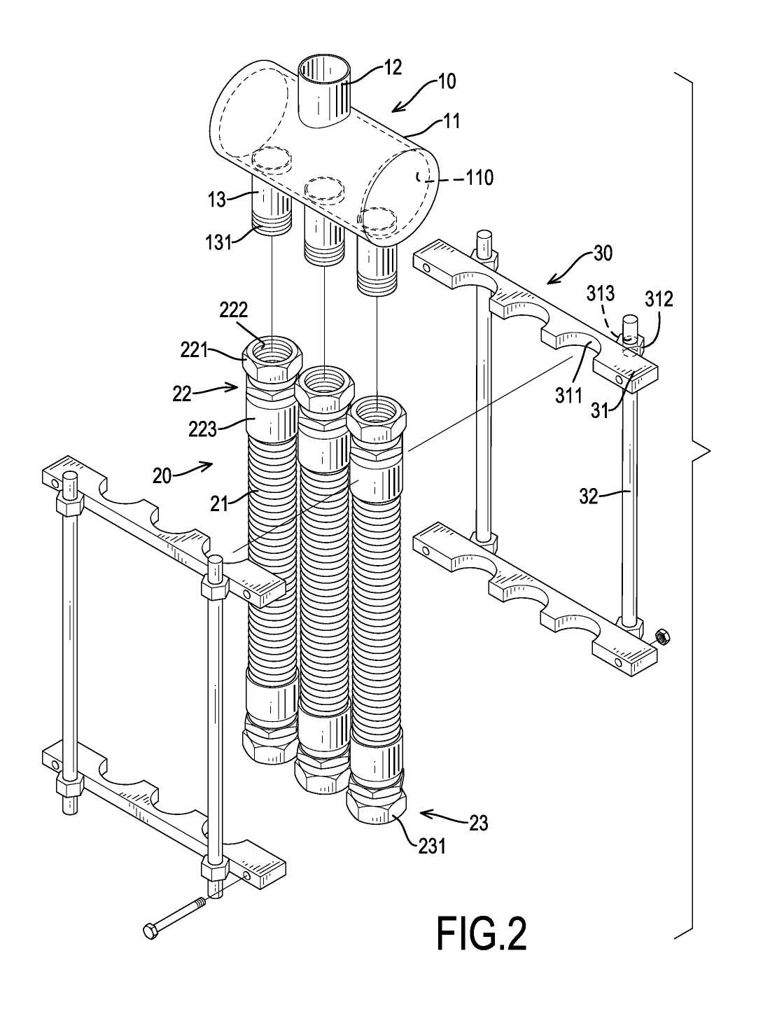

With reference to FIGS. 1 to 3, a first embodiment of a filtering apparatus in accordance with the present invention comprises a tank 10, multiple filters 20 and two brackets 30.

The tank 10 has a main body 11, an overflow 12 and multiple connecting tubes 13. The main body 11 is hollow and cylindrical. The main body 11 has an inner space 110 and an outer surface. The overflow 12 is tubular, is connected with the outer surface of the main body 11 and communicates with the inner space 110 of the main body 11. The connecting tubes 13 are connected with the outer surface of the main body 11 beside the overflow 12 and communicate with the inner space 110 of the main body 11. Preferably, there are three of the connecting tubes 13, and each connecting tube 13 has a distal end and an exterior threaded surface 131. The distal end of the connecting tube 13 has an outer surface. The exterior threaded surface 131 of each connecting tube 13 is formed around the outer surface of the distal end of the connecting tube 13.

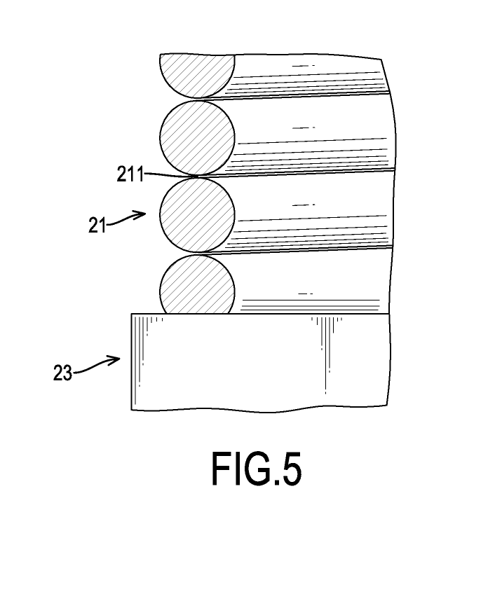

The filters 20 are respectively and securely connected with the connecting tubes 13. The amount of filters 20 corresponds to the amount of the connecting tubes 13 and in this embodiment three filters 20 are implemented. Each filter 20 has an outer surface, an extension spring 21 and two joints. The extension spring 21 of each filter 20 has two opposite ends and a helical gap 211, shown in FIG. 5. The helical gap 211 of each extension spring 21 is formed through an outer surface and between the ends of the extension spring 21, and serves as a mesh. The joints of each filter 20 are respectively mounted around the ends of the extension spring 21. The two joints of each filter 20 are respectively defined as a first joint 22 and a second joint 23. The first joint 22 of each filter 20 is connected with a corresponding one of the connecting tubes 13 and has an end, a nut section 221, a threaded hole 222 and a tube section 223. The nut section 221 of each first joint 22 is formed at the end of the first joint 22. The threaded hole 222 of each first joint 22 is formed axially in the nut section 221 and is connected with a corresponding one of the exterior threaded surfaces 131. The tube section 223 of each first joint 22 is opposite to the nut section 221 of the first joint 22 and is mounted around one of the ends of a corresponding extension spring 21.

The second joint 23 of each filter 20 is opposite to the first joint 22 of the filter 20 and has a closed end and a nut section 231. The nut section 231 of the second joint 23 of each filter 20 is formed at the closed end of the second joint 23.

The brackets 30 clamp the outer surface of each filter 20 and are securely connected with each other.

Preferably, each bracket 30 has two boards 31 and two posts 32. The boards 31 of each bracket 30 are parallel to each other. The two boards 31 of each bracket 30 respectively abut those of the other bracket 30 and hold the filters 20. Preferably, each board 31 has a first side, a second side, multiple recesses 311, two protrusions 312 and two through holes 313. The second side of each board 31 is opposite to the first side of the board 31. The recesses 311 of each board 31 are semi-circular, are formed in the first side of the board 31 at intervals and are respectively hold outer surfaces of the tube sections 223. The protrusions 312 of each board 31 are formed on the second side of the board 31. The through holes 313 of each board 31 are formed through the protrusions 312 of the board 31.

Each post 32 of each bracket 30 has two opposite ends respectively and securely mounted through the two boards 31 of the bracket 30. Preferably, the ends of each post 32 are mounted through the through holes 313 of the different boards 31 of the bracket 30. With the posts 32, the boards 31 can be securely positioned. Furthermore, the brackets 30 can securely position the filters 20.

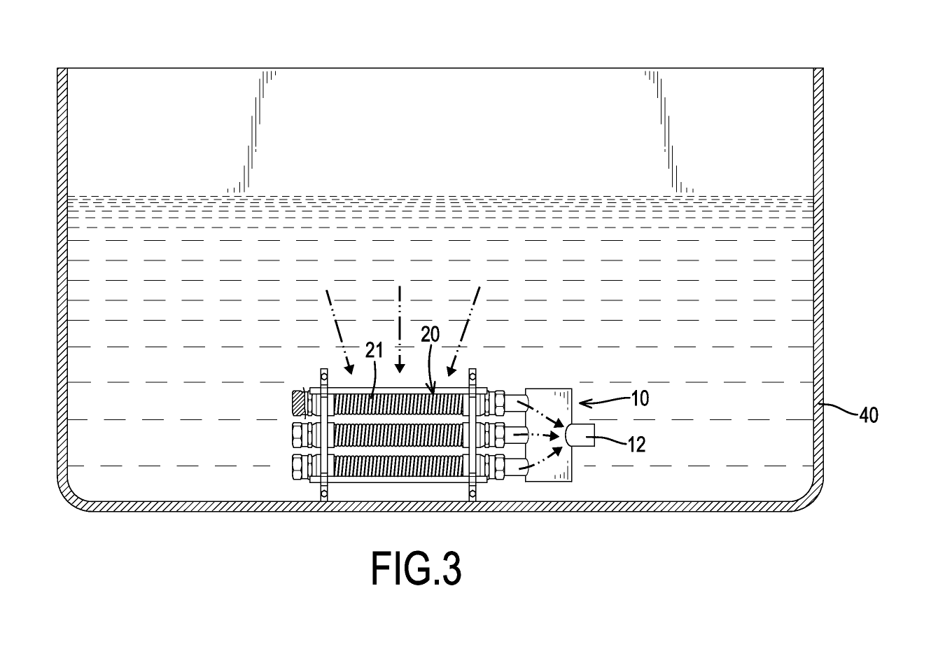

With reference to FIG. 3, the filtering apparatus in accordance with the present invention is placed in a cistern 40 filled with sewage. The overflow 12 may be connected with a pump to generate suction in the tank 10. Accordingly, sewage in the cistern 40 is drawn into the filters 20 due to the suction via the helical gaps 211 of the extension springs 21. Because flow of bulky effluent in the sewage is blocked by the extension springs 21, the sewage is filtered by the filters 20, and the filtered water flows into the inner space 110 of the main body 11 and is pumped into the cistern 40 again. Repeatedly, the water in the cistern 40 is filtered.

To wash the extension springs 20, the extension springs 21 can be detached from the filtering apparatus, and outer surfaces of the extension springs 21 are flushed and cleansed by water. Or, water or air can be pumped into the tank 10 via the overflow 12, and flows out through the helical gap 211 to scatter the accumulated particles. Accordingly, the extension springs 21 are cleansed and can work for subsequent filtering.

The tank 10 may have four or even more connecting tubes 13. Accordingly, four or even more filters 20 can be connected with the tank 10, and surface area of the filters 20 increases to provide a good filtering effect.

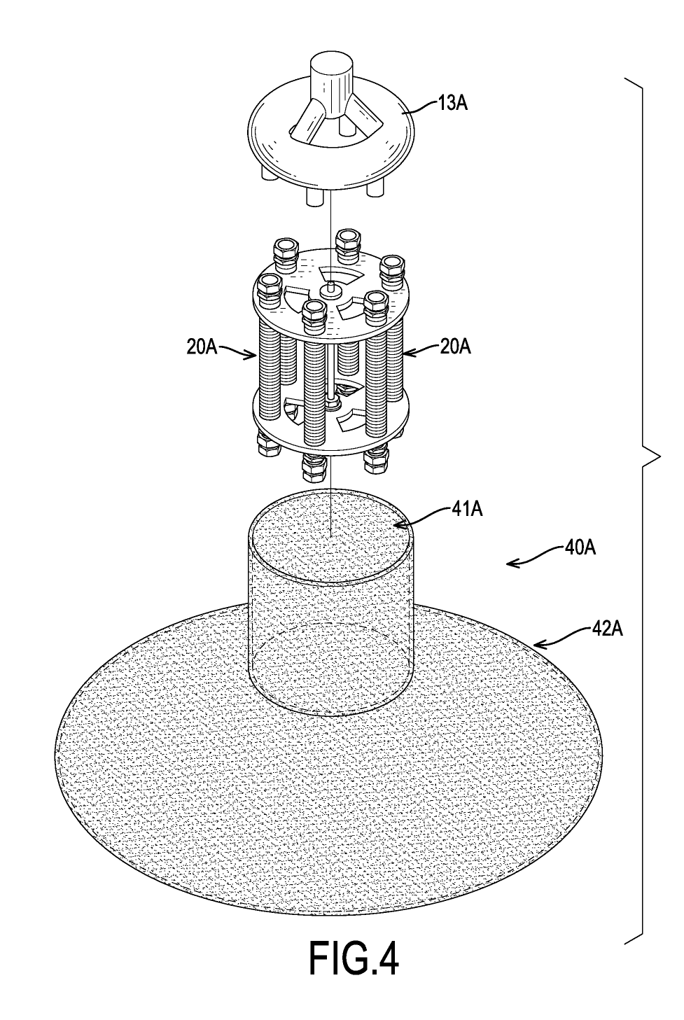

With reference to FIG. 4, a second embodiment of the filtering apparatus in accordance with the present invention is substantially the same as the first embodiment.

Six connecting tubes 13A and six filters 20A are implemented, and the filters 20A are arranged in a circle. The second embodiment further has a hollow cover 40A. The cover 40A has a cylindrical section 41A and a dish section 42A communicating with the cylindrical section 41A. The cylindrical section 41A is mounted around the filters 20A. The dish section 42A can direct water into the cylindrical section 41A.

From the above description, it is noted that the present invention has the following advantages:

1. Arbitrary placement:

The position of the filtering apparatus can be arbitrarily changed, whereby the filtering apparatus can be placed at different locations as a user's requirement, which is greatly convenient.

2. Reuse and easy maintenance:

The extension springs 21 are quickly washed and cleansed with ease, so they are easily maintained. Furthermore, the extension springs 21 are reusable and do not need to be replaced.

3. Good filtering effect:

Because multiple filters 20,20A are implemented, surface area of the filters 20,20A increases, and a good filtering effect is provided.

4. Adjustable gap:

The functional lengths of the extension springs 21 can be adjusted by replacing the posts 32 of different length. When the lengths of the extension springs 21 change such as in great extension, the widths of the helical gaps of the extension springs 21 also change and are capable of blocking particles of different sizes.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A filtering apparatus comprising:
a tank having
a hollow main body having an inner space and an outer surface;
a tubular overflow connected with the outer surface of the main body and communicating with the inner space of the main body; and
multiple connecting tubes connected with the outer surface of the main body and communicating with the inner space of the main body;
multiple filters respectively connected with the connecting tubes, each filter having:
an outer surface;
an extension spring having
a first end;
a second end opposite to the first end of the extension spring; and
a helical gap formed through an outer surface of the extension spring and between the first end and the second end of the extension spring;
a hollow first joint mounted around the first end of the extension spring of a corresponding one of the filters, wherein the extension spring is in communication with the tank via the first joint; and
a second joint mounted around the second end of the extension spring of a corresponding one of the filters and having a closed end; and
two brackets securely connected with each other and clamping the outer surface of each filter.

2. The filtering apparatus as claimed in claim 1, wherein
each bracket has
two boards parallel to each other; and
two posts, each post having two opposite ends respectively and securely mounted through the two boards of the bracket; and
the two boards of each bracket respectively abut those of the other bracket and hold the filters.

3. The filtering apparatus as claimed in claim 2, wherein
each connecting tube has
a distal end having an outer surface; and
an exterior threaded surface formed around the outer surface of the distal end of the connecting tube; and
the first joint of each filter has
an end;
a nut section formed at the end of the first joint; and
a threaded hole formed axially in the nut section and connected with a corresponding one of the exterior threaded surfaces; and
the second joint of each filter is opposite to the first joint and has
a nut section formed at the closed end of the second joint.

4. The filtering apparatus as claimed in claim 1, wherein three filters and three connecting tubes are implemented.

5. The filtering apparatus as claimed in claim 2, wherein three filters and three connecting tubes are implemented.

6. The filtering apparatus as claimed in claim 3, wherein three filters and three connecting tubes are implemented.
